(19) United States
(12) Patent Application Publication
(10) Pub. No.: US 2022/0147945 A1
(43) Pub. Date: May 12, 2022

(54) SKILL DATA MANAGEMENT

(71) Applicant: Macnica Americas, Inc., Solana Beach, CA (US)

(72) Inventors: Daichi Yoshikawa, Campbell, CA (US); Daisuke Nishimura, Cupertino, CA (US)

(21) Appl. No.: 17/522,768

(22) Filed: Nov. 9, 2021

Related U.S. Application Data
(60) Provisional application No. 63/111,547, filed on Nov. 9, 2020.
(60) Provisional application No. 63/111,551, filed on Nov. 9, 2020.
(60) Provisional application No. 63/223,489, filed on Jul. 19, 2021.

(51) Int. Cl. G06Q 10/10; G06F 16/901

(52) U.S. Cl. CPC G06Q 10/1053; G06F 16/9024

(57) ABSTRACT

Skill data management techniques include extracting keywords for skill data obtained from experiences of individuals. Skill data management includes representing skill data in graph format including edges and nodes, suppressing duplicate data, and managing aliases. Managed skill data can be used for hiring, recruiting, internal placement, career planning, training, and issue solving.

### REFERENCE TO RELATED APPLICATIONS

This patent application claims the benefit of each of the following U.S. Provisional patent applications:
U.S. Prov. Ser. No. 63/111,547 filed Nov. 9, 2020;
U.S. Prov. Ser. No. 63/111,551 filed Nov. 9, 2020; and
U.S. Prov. Ser. No. 63/223,489 filed Jul. 19, 2021.

This application incorporates by reference each of the above-identified three patent applications. This patent application is related to and incorporates by reference U.S. patent application Ser. No. ______ filed on Nov. 9, 2021 (Attorney Docket No. 360-0003US. The above-referenced provisional and non-provisional patent applications are collectively referenced herein as “the commonly assigned incorporated applications.”

### FIELD

This patent specification generally relates to skill data management. More particularly this specification relates to systems and techniques for managing and using skill data obtaining from a population of individuals.

### BACKGROUND

Companies are increasingly facing a “digital skill gap” of employees. Some estimate that more than half of all employees will require significant reskilling by 2022. The gap is inevitable because many kinds of markets are driven and accelerated by digital technologies, and people who own some expertise in a specific domain need to catch up to new demands in the markets. To address the digital skill gap, companies are trying to more fully utilize existing resources, for example, by training/educating employees and/or re-assigning employees. Companies are also trying to address the digital skill gap by looking outside, for example, by finding and hiring new employees with required skill sets, or outsourcing from a third party.

### SUMMARY

According to some embodiments, a method of exploiting skill data that speeds up an involved network system and reduces computer memory requirements, comprises: computer-processing work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills; computer-processing the extracted skill data into graphs each comprising a plurality of nodes interconnected by a plurality of edges as distinguished from a tree listing of skills, said nodes and edges each having one or more skill-related attributes associated therewith; computer-processing said skill data and/or said graphs of nodes and edges, to suppress duplicates of skill data, including duplicates by alias and abbreviation, thereby reducing computer storage requirements of skill data in said graphs and in merged graphs compared with tree structures of skill data; computer-processing said graphs of nodes and edges to selectively produce clustered skill data represented as graphs of nodes and edges; computer-processing the skill data to produce productivity maps that non-linearly relate periods of experience in skills and productivity in skills; storing smart filters that specify a search request for skill data by selected pluralities of attributes of skills, and searching the skill data by identities of said special filters rather than by listing the attributes included therein, thereby reducing errors in listing attributes of the special filters for searches and speeding up the involved networked system by reducing bandwidth of communicating search requests; and utilizing said skill data and maps for computer-automated fitting of needs for skills to availability of skills.

The method can further comprise one of more of the following features: (a) said producing of productivity maps comprises applying to said graphs of skill data a combination of weights representing types of available experience in said skill, whether the experience is current, how recent is the experience, endorsement by others regarding said skill or experience, and periods of experience; (b) further including bottom-up dynamic editing of said nodes and/or edges in one or more of said graphs by user and/or expert input; (c) further including computer-processing a selected subset of said skill graphs to produce a team graph of nodes and edges representing combined skills of team members; (d) further including computer-processing a selected subset of said skill graphs to produce a team graph of nodes and edges representing combined skills of team members and further representing prioritized nodes and/or edges based on quality or extent of related skills; (e) said suppressing of duplicates of skill data comprises producing and storing aliases and abbreviations of skill names and using said stored aliases and abbreviations to suppress duplicates of nodes and/or edges; (f) further including producing graphs of non-linear relationships between periods of experience of individuals in respective skills and using said non-linear relationships in producing said productivity maps; (g) further including processing said graphs of nodes and edges to produce maps of geographical distributions of skills; and (h) said computer-processing of work experience date comprises presenting users with listings of skills over a network connection for selection of skills by users from said listings.

According to some embodiments, a method of exploiting skill data that speeds up an involved network system and reduces computer memory requirements, comprises: computer-processing work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills; computer-processing the extracted skill data into graphs each comprising a plurality of nodes interconnected by a plurality of edges as distinguished from a tree listing of skills, said nodes and edges each having one or more skill-related attributes associated therewith; computer-processing said skill data and/or said graphs of nodes and edges to suppress duplicates of skill data, including duplicates by alias and abbreviation, thereby reducing computer storage requirements of skill data in said graphs and in merged graphs compared with tree structures of skill data; computer-processing said graphs of nodes and edges to selectively produce clustered skill data represented as graphs of nodes and edges; computer-processing the skill data to produce productivity maps that non-linearly relate periods of experience in skills and productivity in skills; storing smart filters that specify a search request for skill data by selected pluralities of attributes of skills, and searching the skill data by identities of said special filters rather than by listing the attributes included therein, thereby reducing errors in listing attributes of the special filters for searches and speeding up the involved networked system by reducing bandwidth of communicating search requests; and utilizing said skill data and maps for computer-automated fitting of needs for skills to availability of skills.

The method described in the immediately preceding paragraph can further comprise one of more of the following features: (a) said producing of productivity maps comprises applying to said graphs of skill data a combination of weights representing types of available experience in said skill, whether the experience is current, how recent is the experience, endorsement by others regarding said skill or experience, and periods of experience; (b) further including bottom-up dynamic editing of said nodes and/or edges in one or more of said graphs by user and/or expert input; (c) further including computer-processing a selected subset of said skill graphs to produce a team graph of nodes and edges representing combined skills of team members; (d) further including computer-processing a selected subset of said skill graphs to produce a team graph of nodes and edges representing combined skills of team members and further representing prioritized nodes and/or edges based on quality or extent of related skills; (e) said suppressing of duplicates of skill data comprises producing and storing aliases and abbreviations of skill names and using said stored aliases and abbreviations to suppress duplicates of nodes and/or edges in said graphs and/or in said clustered skill data; (f) further including producing graphs of non-linear relationships between periods of experience of individuals in respective skills and using said non-linear relationships in producing said productivity maps; (g) further including processing said graphs of nodes and edges to produce maps of geographical distributions of skills; and (h) said computer-processing of work experience date comprises presenting users with listings of skills over a network connection for selection of skills by users from said listings.

According to some embodiments, a system exploiting skill data comprises: a computer-implemented facility configured to process work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills; a computer-implemented facility configured to convert the extracted skill data into graphs each comprising a plurality of nodes interconnected by a plurality of edges as distinguished from a tree listing of skills, said nodes and edges each having one or more skill-related attributes associated therewith; a computer-implemented facility configured to suppress duplicates of skill data in said graphs, including duplicates by alias and abbreviation, thereby reducing computer storage requirements of said graphs and merged versions thereof compared with tree structures of skill data; a computer-implemented facility configured to combine selected graphs of nodes and edges to selectively produce clustered skill data represented as graphs of nodes and edges; a computer-implemented facility configured to produce productivity maps that non-linearly relate periods of experience in skills and productivity in skills; a computer-implemented facility configured to store smart filters that specify a search request for skill data by selected pluralities of attributes of skills, and to search the skill data by identities of said special filters rather than by listing the attributes included therein, thereby reducing errors in listing attributes of the special filters for searches and speeding up an involved network system by reducing transmission of search requests that include a listing of attributes; and a computer-implemented facility configured to utilize said skill data and maps for computer-automated fitting of needs for skills to availability of skills.

The system can further include a computer facility configured for bottom-up dynamic editing of said nodes and/or edges in one or more of said graphs by user and/or expert input.

As used herein, the grammatical conjunctions “and”, “or” and “and/or” are all intended to indicate that one or more of the cases, object or subjects they connect may occur or be present. In this way, as used herein the term “or” in all cases indicates an “inclusive or” meaning rather than an “exclusive or” meaning.

### BRIEF DESCRIPTION OF THE DRAWINGS

To further clarify the above and other advantages and features of the subject matter of this patent specification, specific examples of embodiments thereof are illustrated in the appended drawings. It should be appreciated that elements or components illustrated in one figure can be used in place of comparable or similar elements or components illustrated in another, and that these drawings depict only illustrative embodiments and are therefore not to be considered limiting of the scope of this patent specification or the appended claims. The subject matter hereof will be described and explained with additional specificity and detail through the use of the accompanying drawings in which:

FIG. 1 is a diagram illustrating an example of system architecture for skill data management, according to some embodiments;

FIG. 2 is a diagram illustrating aspects of extraction and prediction of user skills, according to some embodiments;

FIG. 3 is diagram illustrating an example graph of skill data, according to some embodiments;

FIG. 4 is a diagram showing a tree of the same skill data as in FIG. 3;

FIG. 5 is a diagram illustrating merged skill tree skill data, according to some embodiments;

FIG. 6 is a diagram illustrating a merged skill graph, according to some embodiments;

FIGS. 7A-7E are table diagrams illustrating examples of tables of a skill database, according to some embodiments;

FIG. 8 is a table showing examples of duplicate skill data, according to some embodiments;

FIG. 9 is plot of a productivity curve, according to some embodiments;

FIG. 10 is a diagram illustrating an estimated productivity map in graph form, according to some embodiments;

FIG. 11 is Table 2, which shows an example of categorized experience periods, according to some embodiments;

FIG. 12 is a diagram illustrating an example of skill alias graphs, according to some embodiments;

FIG. 13 is a diagram illustrating editing of skills alias graphs, according to some embodiments;

FIG. 14 is a diagram showing an example of edited skill alias graph updates being reflected to each user's skill graph, according to some embodiments;

FIGS. 15 and 16 are diagrams illustrating examples of geographical distribution of specific skill(s) shown as a heatmap, according to some embodiments; and

FIG. 17 is a diagram illustrating an example of skill clustering map, according some embodiments.

### DETAILED DESCRIPTION

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

According to some embodiments techniques are described for tracking and updating the skill data of employees and other individuals. The described techniques facilitate more fully utilizing existing human resources within an organization as well as finding, hiring individuals and/or outsourcing tasks to outside individuals. Skill data is difficult to maintain by top-down approach, because it's almost impossible to grasp all possible skills and execute due diligence for each employee. According to some embodiments, the company instead takes a bottom-up approach to handle skill data in a sustainable way.

According to some embodiments, techniques for managing skill data are described. Techniques to extract skill data as reliably/objectively as possible, to apply a graph data structure to skill data for efficient data management, to suppress duplicate skill data to reduce data storage consumption, to cluster/group multiple skill data to see an overview of large skill data map for analysis, and conversion of skill data into productivity and a smart filter used for thorough analysis of skill data.

As used herein the term “skill” is interchangeable with “experience” or “familiarity.” That is, the term “skill” is not limited to the ability to do something professionally. According to some embodiments, described systems and techniques do not accept skills which the user only claims to possess, but are not also accompanied with some industrial and/or academic experiences.

As used herein the term “user” refers to a user of a service for managing skill data. The “service” may be a desktop application, SaaS, or PaaS, etc.

As used herein, the term “edit” refers to actions such as adding, deleting, coping, pasting, and/or modifying something.

When a skill and/or experience: (a) has a parent-child relationship with; (b) is similar to; (c) is used for; or (d) is applied to other skill(s)/experience(s), it is said that the skill and/or experience has a “relevance” to other skill(s) and/or experience(s).

As used herein the terms “skill map” and “skill data map” refer to a set of skill data of an individual user or a group.

As used herein the term “expert” refers to a user who possesses a skill, expertise, familiarity and/or knowledge in a specific domain. An example is an application with which a user searches for experts by a skill name.

As used herein, the term “company” can refer to an organization, school, university, college, governmental facility, institute and/or community.

As used herein, the term “employee” can refer to a student, officer, volunteer, or other person who belongs to a certain organization or company.

As used herein, the term “skill graph” refers to skill data managed as a graph data structure.

As used herein, the term “skill tree” refers to skill data managed as a directory tree structure.

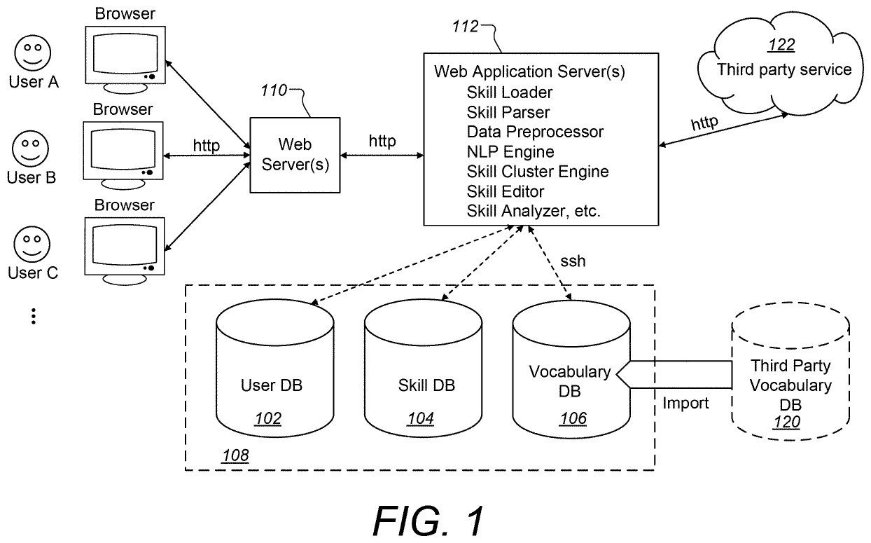

FIG. 1 is a diagram illustrating an example of system architecture for skill data management, according to some embodiments. Since some of the described embodiments relate to skill data management, the architecture can be modified without losing capabilities. For example, according to some embodiments, one large data base (DB) 108 can contain all of User DB 102, Skill DB 104, and Vocabulary DB 106. According to another example, functionalities of web server 110 and web application server 112 can be implemented as a desktop application. Furthermore, software modules, which need a high computational power, such as NLP (Natural Language Processing) engine, Skill Cluster Engine, etc., may be installed into separate servers for asynchronous processes.

In the above examples, the web application server 112 internally has some software modules (e.g. Skill loader, Skill parser, Data preprocessor, Natural Language Processing (NLP) engine, Skill Editor, Skill Cluster Engine, and Skill Analyzer) that are elucidated in the description, infra.

Interactions between users and system are done via web server 110, which may also work as a proxy server and/or load balancer, and web application server 112 which contains some software modules relevant to some of the embodiments. Network communication may be encrypted. A reverse proxy may be installed between the web server and web application server. In addition to a general Relational Database System (RDBS) such as MySQL, Postgresql DB, SQLite, or Maria DB, NoSQL DB such as mongoDB, or Graph DB such as Neo4j can be used as User DB 102, Skill DB 104, and/or Vocabulary DB 106 in FIG. 1.

Third party vocabulary DB 120 may be used to initialize vocabulary DB 106 as described herein infra, and a third party service 122 (for example, LinkedIn) may be used to import user profile data to extract user's experiences/skills as described herein infra. As with other aspects of the described embodiments, the use of a third party vocabulary DB 120 and service is optional.

Although the foregoing has been described in some detail for purposes of clarity, it will be apparent that certain changes and modifications may be made without departing from the principles thereof.

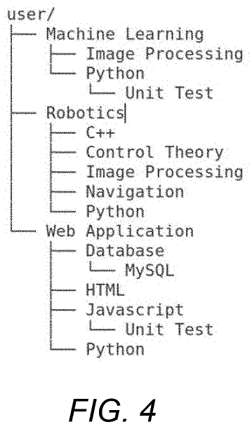

In this section, persistent or recurring problems, or pain points, of general applications or services which require skill data are discussed. Skill data is commonly managed by a tree structure (a directory tree) as shown in FIG. 4, which is described more fully infra. The structure shown in FIG. 4 is very popular in computer science (for example, Microsoft Windows' folder is using a directory tree) and useful to represent parent-child relationships (in other words, layered structure). However, when it comes to handling skill data, it comes with greater disadvantages. Here are the remarkable disadvantages.

Lack of consistency criteria with respect to a parent-child relationship. A parent-child relationship is very sensitive to individual's subjective decisions, and sometimes impossible to define uniformly. For example, user A may think “Artificial Intelligence (AI)” is a child of “Optimization” because optimization is a very broad technique and AI can be taken as one of applications using optimization technique, but User B may think “Optimization” is a child of “AI” because User B has used specific optimization technique to implement some AI application.

Redundancy of storing skills with multiple parents. For example, skills “Machine Learning”, “Robotics”, “Web Application” can be parents of a skill “Python” at the same time.

Difficulty of merging a skill map into another skill map. Because of the two pain points described above, merging a skill map represented in a directory tree into another skill map is difficult. For example, if user A has a skill “AI” as child of “Optimization” and user B has a skill “Optimization” as a child of “AI”, merging those users' skill maps forms a loop so those can't be merged correctly, or produces data which looks duplicated.

Inefficiency and maintenance cost of editing user/group skill map. For example, if a user has a skill data “Python” under all three directories “Machine Learning”, “Robotics” and “Web Application” and would like to delete “Python” entirely, the user needs to find and select all of the skill data in those directories, and send a delete request to a server. Finding and deleting all 3 “Python” under these directories requires repetitive work and causes higher chance of human error.

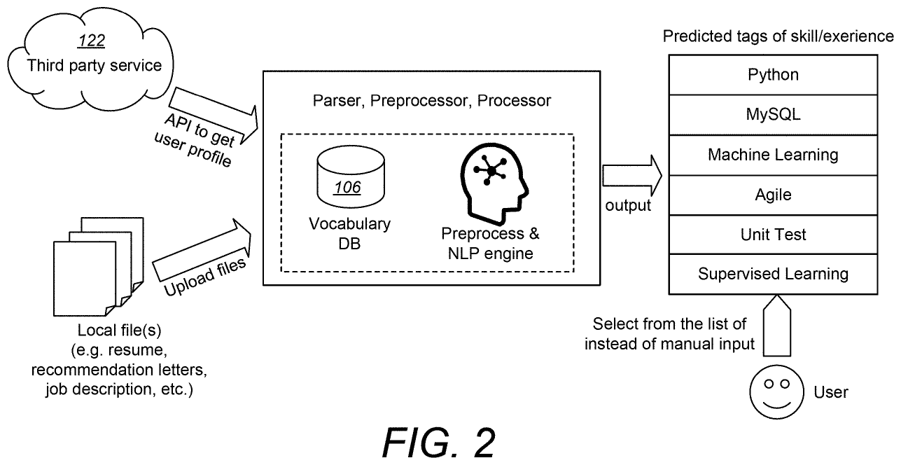

FIG. 2 is a diagram illustrating aspects of extraction and prediction of user skills, according to some embodiments. The system shown includes countermeasures against the above paint point issues.

Extracting Skill Data from Experiences. Further detail of how a extracting skill data from experiences is described in connection with FIG. 2. According to some embodiments, a system/application asks the industrial or academic experiences of the users and extracts proper keywords for skill data from the obtained experiences. According to some embodiments, the system does not ask the user's skill directly, and users won't directly input skill data they claim.

According to some embodiments, the experiences may be input by answering questions asked by the system/application, or by loading user profile (including work experiences, etc.) from local file in format of pdf, doc, docx, etc., or from some 3rd party services such as LinkedIn.

In case of answering the questions, an examples may be: “I worked on XXX, for YYY years in ZZZ field,” where XXX is a skill name such as “Python”, “Medical Devices”, “Sales Engineering”, etc., YYY is an integer value, and ZZZ is a field type such as “industrial”, “academic”, or “home/personal project”, etc. User's supposed to fill the part indicated by underscore.

When loading experiences from local file or third party service, the system parses the documentation or string data first, extracts keywords which are likely to be relevant to experiences or skills, lists them up, and lets the user select the correct one(s). In the process, it may utilize the vocabulary DB 106 to extract keywords, preprocessor to cleanse, reformat, and vectorize string data, and natural language processing with/without machine learning techniques to predict the proper words which represent a user's skill/experience.

Additionally, through parsing user profiles, the system may predict relevances of listed skill data. In a simple example, if keywords of “Python” and “Machine Learning” are found in the same paragraph in the section of work experience, relevance between “Python” and “Machine Learning” may be suggested. According to some embodiments, the added skill data is inserted into the skill DB 104 shown in FIG. 1.

In conventional applications or services, users can list up skills very subjectively. A typical case is where users add skills used in the project which they were working for, but they didn't use firsthand. The subjective input leads to unnecessary storage consumption and an increase of unreliable data. According to some embodiments, the described functionality has users able to input only firsthand skills. In other words, a user is not free to add skills used in the project which the user was working for but the user didn't use firsthand. The described systems therefore have more reliable data. As a result, less data cleansing is needed when visualizing or analyzing data.

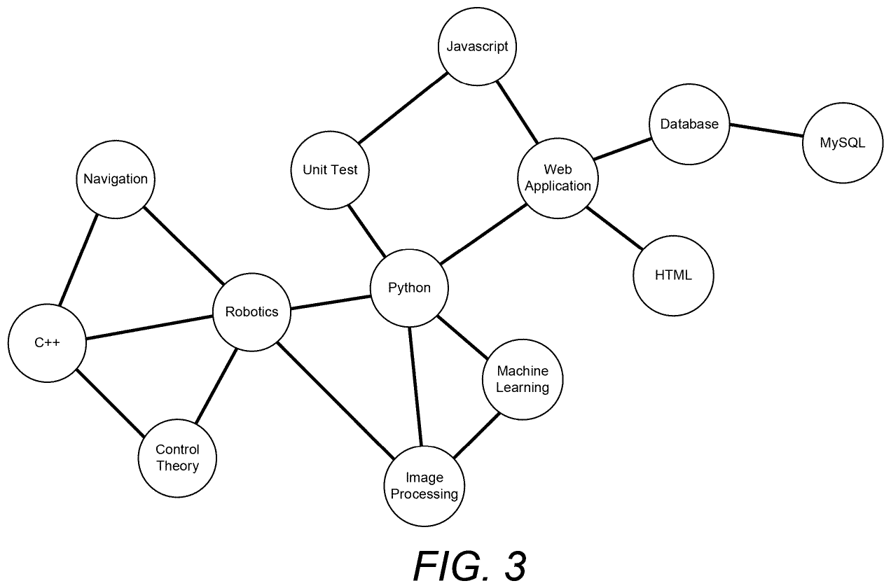

Applying graph to skill data. FIG. 3 is diagram illustrating an example graph of skill data, according to some embodiments. In these examples, skill data is managed in the format of graph instead of directory tree which is generally used in the conventional applications or services. The use of graphs to manage skill data, according to some embodiments provides several benefits.

As shown in FIG. 3, the graph can consists of node(s) and edge(s). The node may be connected to another node(s) by edge(s), and both may have attribute(s) in it.

According to some embodiments, in the skill data management graph, the node may contain the following attributes: name of skill; role type; flag to indicate the skill is relevant to what the user is currently working on; flag to indicate the skill is relevant to what the user was recently working on (if the user is confident enough to answer question(s) relevant to the skill which the user is not currently working on but still remember, set it to true); periods/years to indicate how long the user experienced; flag to indicate if the skill is gained through experience(s) in the industrial field or academic field; text which users freely describe the details of relevant experiences (this may include URLs of some projects); and the number of relevant users.

According to some embodiments, in the skill data management graph, the edge may contain the following attributes: name of relevance; flag to indicate the skill is heavily relevant to each other; attribute to indicate parent-child relationship specifically; text which users freely describe the details of relevance; the number of relevant users.

According to some embodiments, users do not consider the parent-child relationships between one skill/experience and another one, but instead consider if one is relevant to another. For example, if user A has experienced “Python” programming for both “Robotics” and “Machine learning”, “Python” is joined to both “Robotics” and “Machine Learning”. On the other hand, if user B has used “Python” to implement a “Machine Learning” algorithm but has never used “Python” for “Robotics”, “Python” is only joined to “Machine Learning”.

According to some embodiments, the role type of skill data may be used for filtering, merging, or clustering skill data. Role types should be relatively broad and superordinate concepts, such as “Engineering”, “Sales and Marketing”, etc. For example, clustering company-wide skill data may show that the company has a lot of experts regarding “DC motor”, but most experts may be engineers rather than sales, and vice versa. For further analysis, a user may merge skill data only with ones whose role type is “Sales and Marketing”, and then cluster the merged skill data, in order to observe how many non-engineering people are in the company.

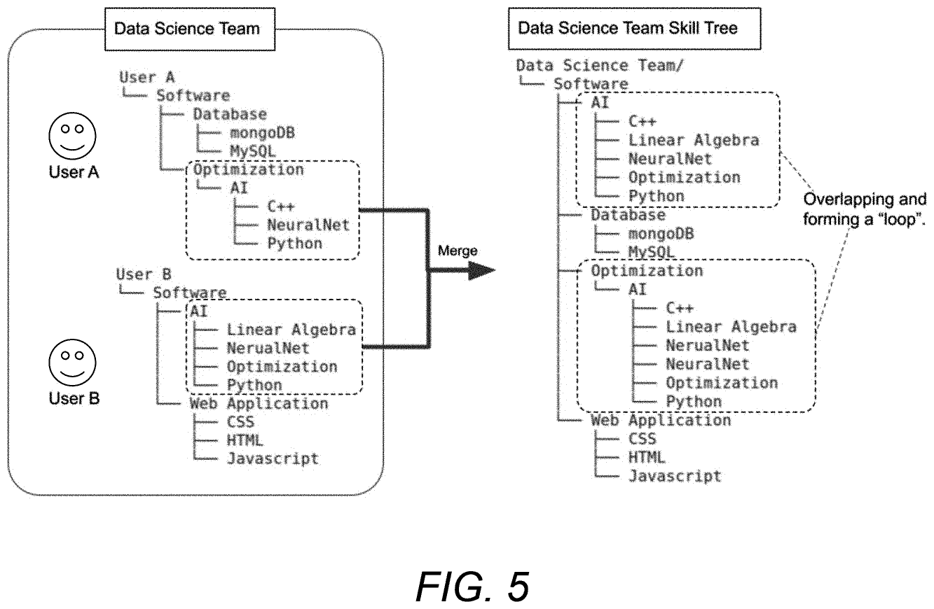

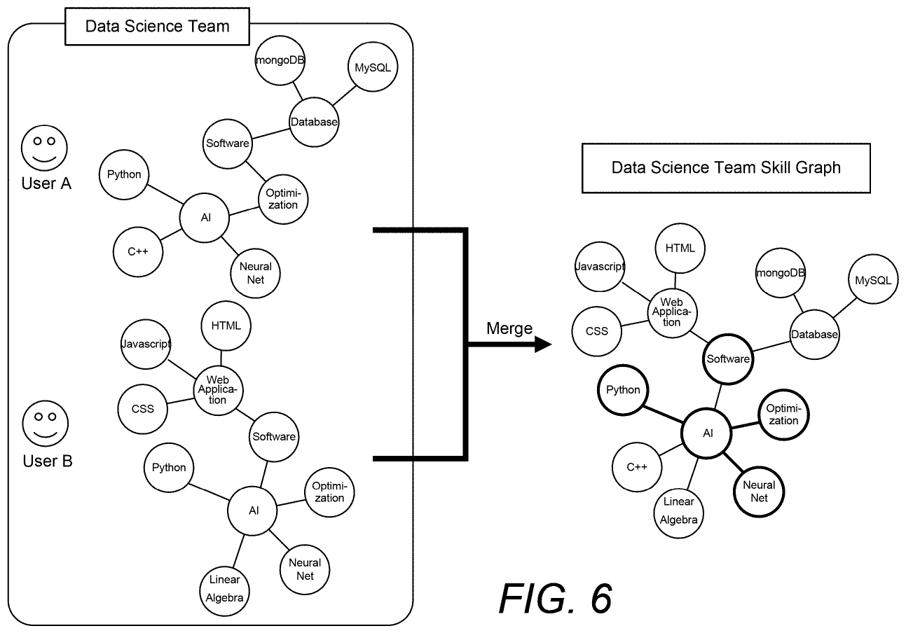

FIG. 4 is a diagram showing a tree of the same skill data shown in a different way in FIG. 3. FIG. 5 is a diagram illustrating merged skill tree skill data. It can be seen from FIG. 5 that some skill are overlapped and form a loop. FIG. 6 is a diagram illustrating a merged skill graph using nodes and edges, according to some embodiments. When managed as a graph, skills are merged and a user can see the owned skill set at a glance and there is no wasteful duplication. Also, the merged skill graph can handle the cases with much more nodes and edges.

Skill data managed by a graph data structure can avoid issues encountered when a directory tree structure, which is commonly used to manage skill data in conventional solutions, is used.

When it comes to managing skill data, one of the biggest differences between a graph and tree structure is whether a parent-child relationship is considered or not. The parent-child relationship brings a number of difficulties, including that it is not optimal for representing a child skill with multiple parent skills. e.g. “Python” can be a child skill of all of “Machine Learning”, “Robotics”, and “Web Application”. With a directory tree, “Python” must appear under all those 3 directories, that is, appear 3 times in total. A skill tree can be redundant compared with a skill graph.

While the parent-child relationship may be good to show relevant skills with respect to a parent skill, is often makes it difficult to see relevant skills with respect to a child skill. For example, see FIG. 4 which shows that the skill tree can limit the capability of viewing/analyzing skill data.

Parent-child relationships can sometimes be inverted (or reversed) depending on the particular users. For example, a User A may think “Artificial Intelligence (AI)” is a child of “Optimization” because an optimization is very broad technique and AI can be taken as one of applications using optimization technique, but User B may think “Optimization” is a child of “AI” because User B has used specific optimization techniques to implement some AI application. Because of this, merging skill trees can result in an unreasonable tree for a skill data management purpose. For example, if a User A has “AI” as a child of “Optimization” and User B has “Optimization” as a child of “AI” as described above, how are their skill trees merged? Probably the result would be like FIG. 5 and it doesn't make sense. Finally, with a parent-child relationship, even a local edit of skill data can influence a skill tree globally. In short, a parent-child relationship is too much information to manage skill data broadly and practically using conventional tree structures. According to some embodiments, a skill graph of notes and edges is used which overcomes many or all of issues in the above relating to parent-child relationships.

Skill alias graph. Skill data is prone to errors because of a variation of its notation. For example, machine learning may be referred to as ML, Artificial Intelligence, AI, etc. and even if users carefully register skill data and its aliases, sometimes users may need to cleanup/organize skill data and aliases at some point.

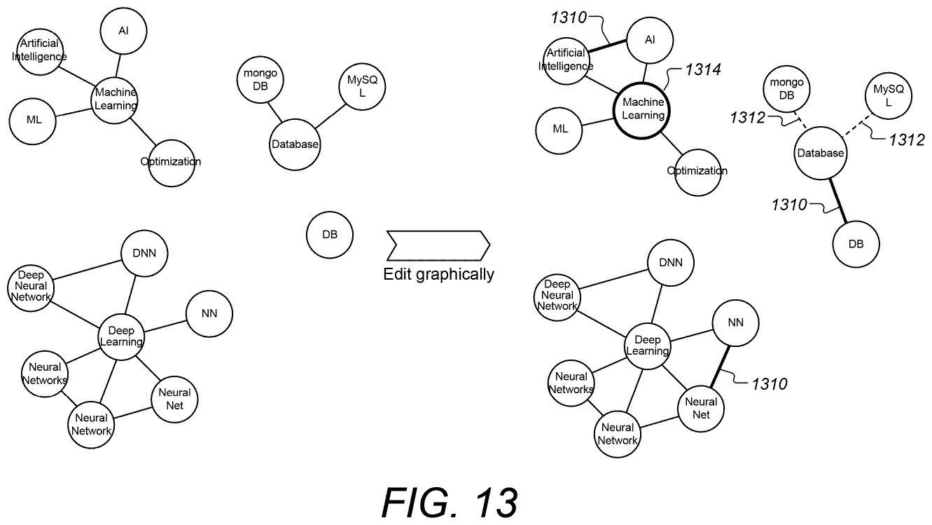

Skill alias graph is a graph data, consisting of nodes and edges, as introduced \” supra, and represents relevances of skill data aliases. FIG. 12 is a diagram illustrating an example of skill alias graphs, according to some embodiments. In skill alias graph 1210, “AI”, “Artificial Intelligence”, “ML”, and “Optimization” are all aliases of “Machine Learning.” Skill alias graph 1212 includes a error such as “DB,” which should be an alias of “Database,” but these nodes are not connected to each other. When editing and/or creating aliases, users may be able to set “representative flag (true or false)” to the aliases. If the representative flag of the skill alias is true, the platform may recommend that a user use the alias instead of other skill names connected to the alias. RDBMS (Relational Database Management System) such as MySQL, Postgresql DB, NoSQL such as MongoDB, and/or a graph database such as Neo4j may be used to store skill data aliases.

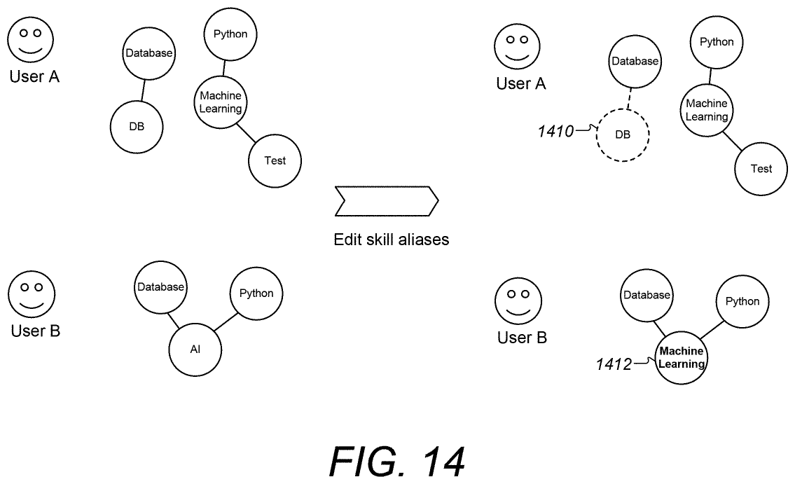

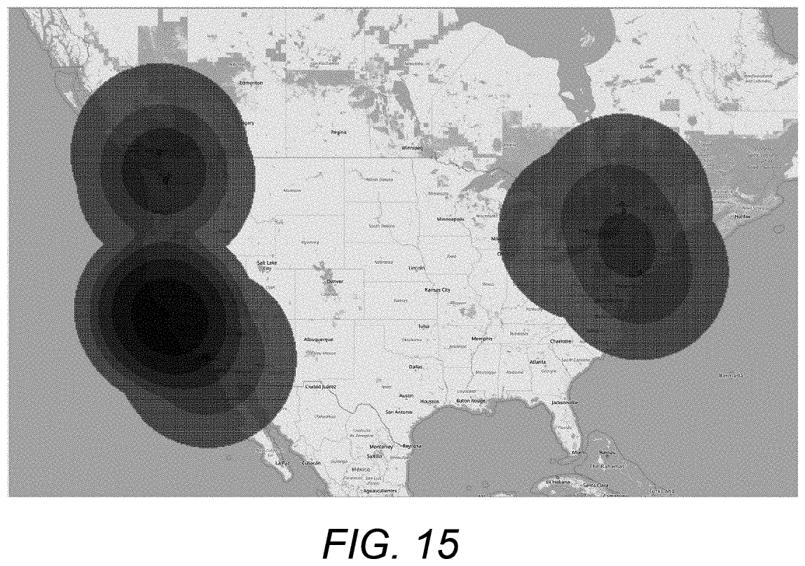

A benefit of the skill alias graph, according to some embodiments, is that graph clustering algorithms can be applied and users can grasp the overview of aliases and users may graphically edit the skill data aliases and organize/unify some scattered skill names. FIG. 13 is a diagram illustrating editing of skills alias graphs, according to some embodiments. Reference number 1310 shows a user adding additional edges. Reference number 1312 shows a user removing edges. Reference number 1314 shows a user setting “representative flag” to true. In this example when a user tries to use “AI,” it may be suggested to the user to use “Machine Learning” instead. FIG. 14 is a diagram showing an example of edited skill alias graph updates being reflected to each user's skill graph, according to some embodiments.

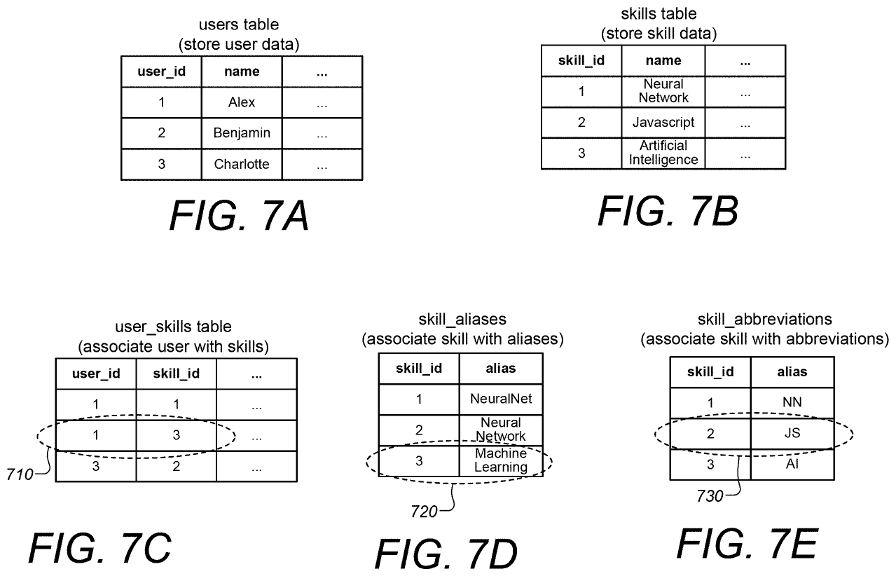

Suppressing duplicate data. According to some embodiments, the skill data management system has skill alias and abbreviation tables in addition to an ordinary skill table. FIGS. 7A-7E are table diagrams illustrating examples of tables of a skill database, according to some embodiments. The tables can be in a skill DB such as skill DB 104 shown in FIG. 1. FIG. 7A shows a users table for storing user data. FIG. 7B shows a skills table for storing skill data. FIG. 7C shows a user skills table which associates users with skills. Dotted oval 710 indicates Alex (user_id is 1) has a skill of artificial intelligence (skill_id is 3). FIG. 7D shows a skill_aliases table which associates skills with aliases. Dotted oval 720 indicates that artificial intelligence may also be referred to as machine learning. FIG. 7E shows a skill_abbreviations DB table which associates skills with abbreviations. Dotted oval 730 indicates that javascript may also be referred to as JS. According to some embodiments, the skill-alias table (FIG. 7D) and the skill_abbreviation table (FIG. 7E) may be initialized by 3rd party DB, and then accumulated by users as described below.

When a user adds skill data and can come up with well-known aliases or abbreviations, the user can register those as well. Registered aliases and abbreviations are inserted into alias and abbreviation DB tables (FIGS. 7D and 7E) respectively to detect aliases and abbreviations other users may try to add. A visual skill map may show only one skill data label and registered aliases and abbreviations may be visible as detailed info. The shown skill data label may be decided by registered date (label registered first), or the number of votes (user may vote to the most common label), etc.

Also, if a user tries to add skill data with the label which is in alias or abbreviation DB table, the user is asked if the skill data can be taken as the same skill data and if answered yes, new record of the skill data is not inserted into any database tables. Just a new record which associates the user with the skill data is inserted into a user-skills DB table.

Furthermore, the system may execute fuzzy matching with input label and labels in skill, alias, and abbreviation DB tables, show candidates, and let users check if the input label has already existed in DB with a similar label. This is especially helpful to find typos of a user for example.

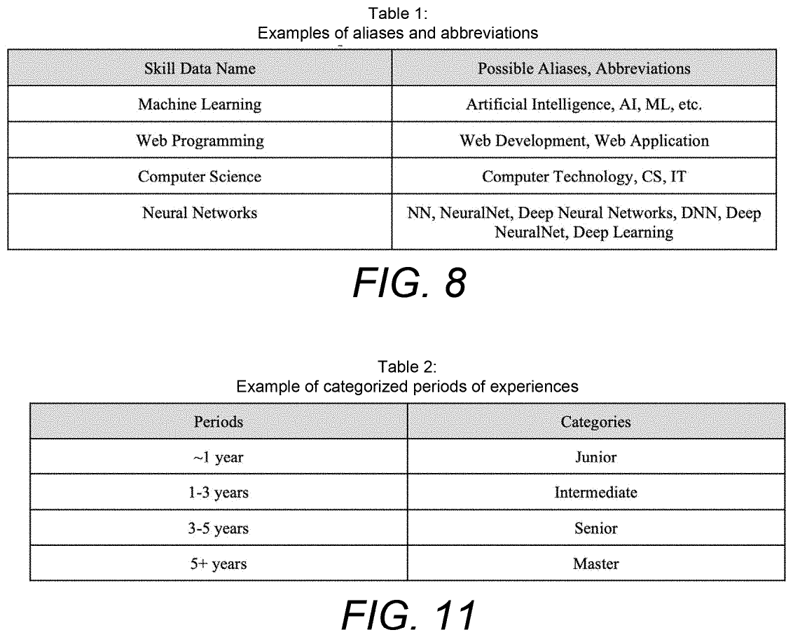

Without the duplicate data such suppression techniques, the amount of duplicate data could easily explode. The major cause of duplicates are (a) alias (Skill “Robotics” is also known as “Robot”), (b) abbreviation (“Computer Science” may be labeled as “CS”) and (c) typo. FIG. 8 is a table showing examples of duplicate skill data, according to some embodiments. In some cases, some examples may be overly aggressive to take as an alias (for example, Computer Science and IT). In each case, it is up to the organization on how aliases are defined.

The techniques described herein can significantly reduce the chances of having multiple records which can be used with the same meaning. That is, the redundancy of skill data is reduced or minimized. In many cases this is beneficial from both a system and user experience perspectives, because it clearly reduces storage consumption (without this functionality, users may add all possible labels as their skills) and users have less chances to get confused with similar labels of skill data.

Skill Data Clustering. Many kinds of graph clustering have been proposed in the academic domain, and users may be able to choose one of the algorithms which they prefer or like to try. The algorithms can be roughly split into two types, a top-down approach and bottom-up approach. From the perspective of skill data's characteristic, the bottom-up approach is generally considered a proper choice, because top-down approaches tend to overlook smaller clusters, which may provide important information like “You have a data science team, but very small,” when it comes to skill data management.

According to some embodiments, a clustering algorithm is used which is a modified version of Louvain algorithm. The Louvain algorithm is discussed more fully in Blondel, Vincent ID; Guillaume, Jean-Loup; Lambiotte, Renaud; Lefebvre, Etienne, “Fast unfolding of communities in large networks”, Journal of Statistical Mechanics: Theory and Experiment, 2008, which is incorporated by reference herein, and hereinafter referred to as “Blondel et al.” The clustering algorithm especially useful when users see an organization or team wide skill map, because a large skill map represented in a graph shows too much information and users cannot observe/analyze data from macro view. It generates intermediate outcomes as well as the final outcome, and these are naturally corresponding to hierarchical structure of skill data and can be used for multi-level zoom in/out of graph visualization.

Clustered skill data can be used for data visualization, and further analyses, such as investigation of weakness of skill cluster in the company, etc. Visualized clustered skill data looks very similar to the raw skill data. However, the skill clusters may be labeled by users, and contain attributes of each cluster, such as a list of merged skill data/cluster, the number of merged nodes, the number of edges in it, the number of unique users in the cluster, etc. Visual effects depending on some attribute may be used. For example, the size of the cluster node may represent the number of unique users.

The described algorithm not only clusters the skill data but also allows users to take into account their prior knowledge about the outcome unlike other clustering algorithms. The described algorithm is illustrated in the following numbered blocks.
(1) Configure explicit partition; A user may specify some nodes which should never be merged to each other.
(2) Configure warm-up nodes; A user may specify some nodes which are used in block 3.
(3) Warm up the clustering; Iterate N times (where N is a user-configurable integer) of blocks 4-8, but only use nodes specified in block 2, nodes joined the specified nodes, and nodes joined clusters containing the specified nodes.
(4) Assign a different cluster to each node.
(5) For each node I, consider the neighbors j of i and evaluate the gain of modularity that would take place by removing i from its community and by placing it in the community of j.
(6) The node i is then placed in the community for which this gain is maximum (in case of a tie, use a breaking rule), but only if conditions of (a) the gain is positive, (b) at least one of nodes is not specified in block 1, and (c) at least one of nodes are not in clusters derived in block 3 or both nodes are supposed to be in the same cluster in block 3, are all met. If not, i stays in its original community.
(7) Repeat blocks 5-7 sequentially until no further improvement can be achieved.
(8) Build a new graph whose nodes are now the communities found during blocks 4-8, by configuring the weights of the edges between the new nodes as the sum of the weights of the links between nodes in the corresponding 2 clusters, and configuring the weights of the edges between nodes of the same cluster as the self-loop for the cluster in the new graph.
(9) Repeat blocks 4-8, until there are no more changes and a maximum of modularity is attained.

When it comes to clustering of skill data, users sometimes would like to reflect their prior knowledge of skill and possible skill clusters on the outcome. The prior knowledge may be split into two types.

Knowledge about skills which shouldn't be merged but may be merged by clustering. For example, users may want to keep skill “Math” and “Data Science” separate though they may be merged by general clustering algorithms. Since a graph clustering algorithm is unsupervised, these are not controllable. This is attained by blocks 1 and 6.

Knowledge about skills which are preferably taken as a center or at least neighbors of a center of some cluster. For example, a user may think that a skill “Machine Learning” should be a center or at least neighbors of the center of the cluster containing machine learning algorithms such as logistic regression, neural networks, and random forest, etc. The warm-up in block 3 makes clustering results tend to have such a cluster. This does not guarantee that the resulting clusters always have the specified skills as a center or neighbors of a center. It just makes the tendency that the skills get close to the center of some cluster stronger. This is done by blocks 2 and 3.

Geographical visualization/analysis of skill data. According to some embodiments, users may register their locations where they usually work, and also register their skills based on experiences. By combining these data, a geographical distribution of expertises within the organization can be visualized providing insights for business strategy, resource planning, and reorganization with consideration of geographical differences of labor costs.

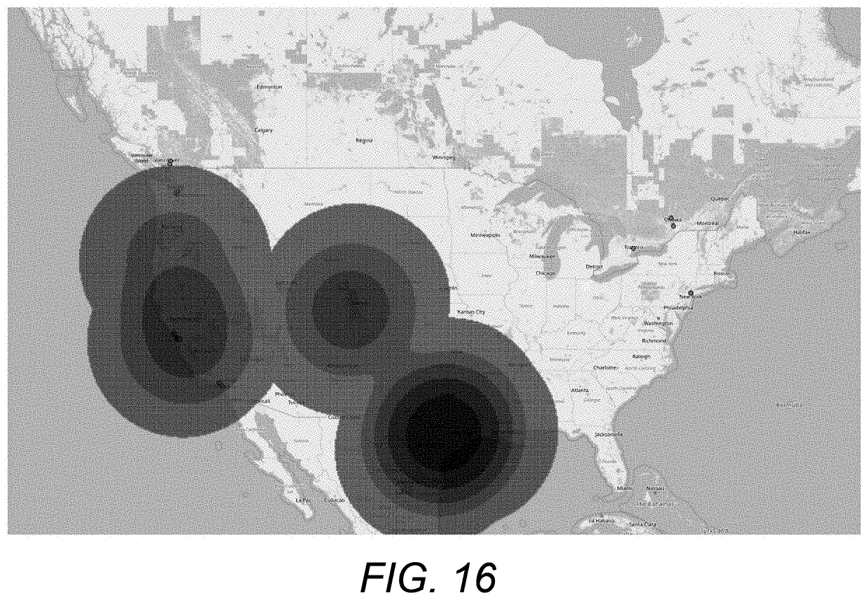

Geographical Skill Heatmap. FIGS. 15 and 16 are diagrams illustrating examples of geographical distribution of specific skill(s) shown as a heatmap, according to some embodiments. The heatmap shown in FIG. 15 illustrates the distribution of AI experts within an organization in the US. According to the heatmap, they are mostly located on the east coast and west coast. FIG. 16 illustrates an example of geographical distribution of semiconductor experts. According to some embodiments, heatmaps may be created per skill and/or per skill set.

The heatmaps are beneficial for grasping the big picture of talent distribution and can be used to evaluate how the distribution is supporting a company's business goals. For example, suppose that this global corporation providing an online software service saw the distribution of its DevOps experts (Here, DevOps experts are supposed to be responsible for operation of production systems) and noticed that most of them are in Japan. Now it's revealed that it would be critical if some infrastructure issue happens during the night in Japan time, that is, while DevOps experts in Japan are unavailable, so the company may hire new DevOps experts in locations whose timezone cover the missing time slots implementing the “follow the sun” operation for better customer experience.

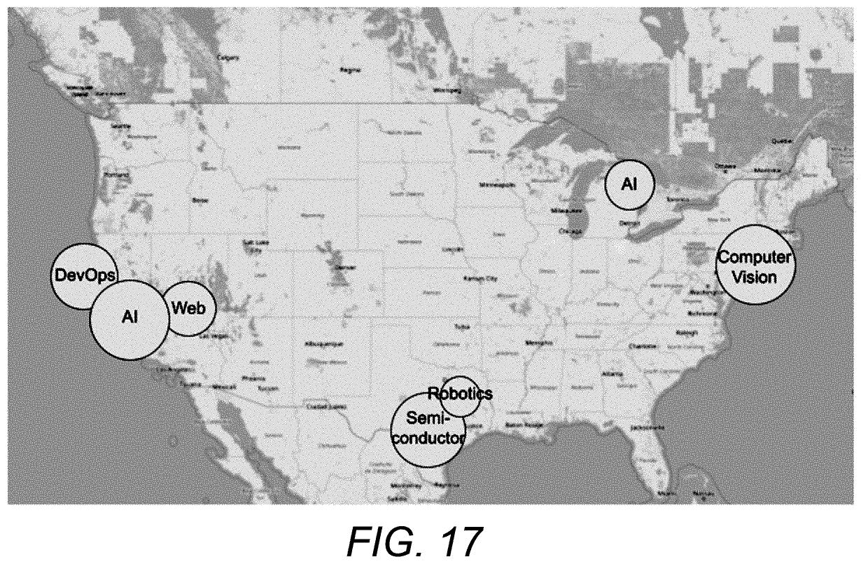

Geographical Skill Clustering Map. Similar to the skill heatmaps shown in FIGS. 15 and 16, skill clustering can be geographically visualized. FIG. 17 is a diagram illustrating an example of skill clustering map, according some embodiments. Note that in FIG. 17, skill cluster “AI” appears twice. This is because graph clustering algorithms are applied to user skill data per geographical location, rather than per organization.

The geographical visualization of skill(s) may be utilized for the following benefits, according to some embodiments: (1) Gain insight for business strategy and/or resource planning; (2) Optimize labor costs, e.g., the platform can indicate if there is a region where employees have the same level of skill and experience as any other region but with lower hiring or labor cost suggesting that HR can focus hiring effort in the region; (3) Inform how the company's engineers are globally distributed to support its world-wide customers, e.g., show how experts in various aspects of a product are geographically distributed to maintain a high service level for customers, and help them feel assured about purchasing the product.

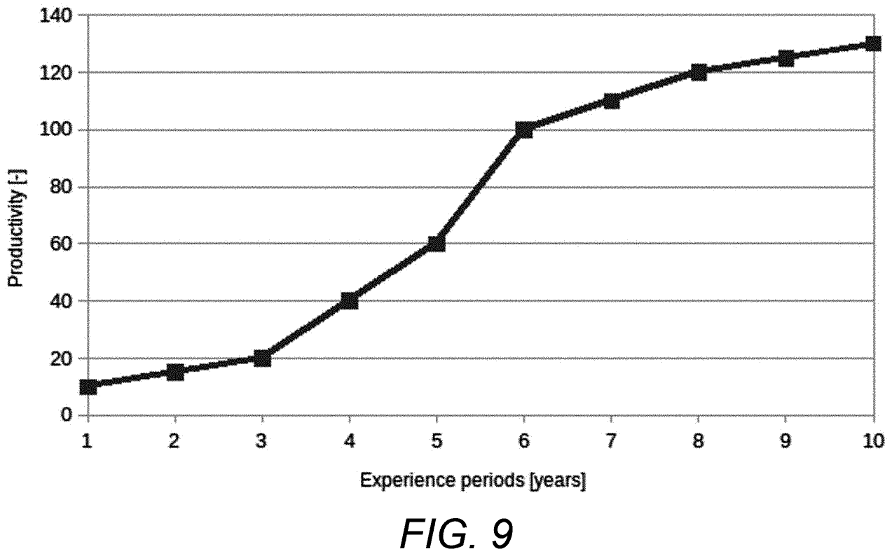

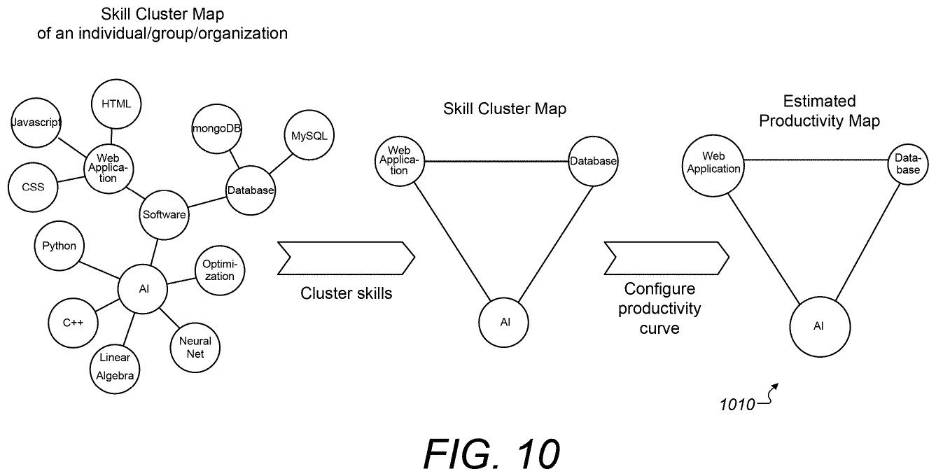

Estimated Productivity Map. FIG. 9 is plot of a productivity curve, according to some embodiments. The productivity curve shown is an estimated productivity map of an individual, group, or organization. The productivity map is based on skill data and its attributes, such as periods of experiences, experience type (industrial, academic, personal projects, etc.), etc. The productivity is calculated skill-wise and/or skill-cluster-wise (regarding skill cluster). FIG. 10 is a diagram illustrating an estimated productivity map in graph form, according to some embodiments. The skill cluster map indicates what kind of skill sets owned by an organization, and the estimated productivity map indicates what kind of skill sets employees are good at. The productivities may be indicated by some visual effects, or show skill-wise/skill-cluster-wise charts as shown in FIG. 10.

Firstly, a user can set a baseline of the productivity curve like one in FIG. 9. The baseline of the productivity curve has x-axis and y-axis as experience periods and productivity respectively. The default productivity curve may be provided, and the user tweaks the curve by moving points of productivity up and down graphically, or input exact values of specific points, and tweaked points are connected smoothly (for example, use Bezier curve), or linearly (curve will be a line curve). Multiple productivity curves may be set by the user with different names, in order to apply different types of productivity curves to different types of skill-clusters (for example, the productivity curve for software engineer's skills may be different from one for hardware engineer's skill). In this phase, the user may quote the curve from some well-known productivity curve, such as one introduced in Meilir Page-Jones, “The Seven Stages of Expertise in Software Engineering”, 1998 (http://www.wayland-informatics.com/The%20Seven%20Stages%20of%20Expertise%20in%20Software.htm), which is incorporated by reference herein.

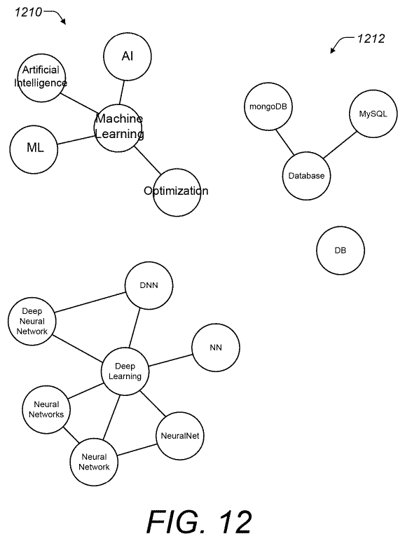

Here, experience periods and/or productivity may be categorized. FIG. 11 (Drawing sheet 8/16) is Table 2, which shows an example of categorized experience periods, according to some embodiments. The number of bins, range of periods, and bin labels are customizable.

Secondly, a user can apply weights to the baseline of productivity with skill data's attributes. According to some embodiments, the following factors may be used as weights: is it industrial or academic experience? (=W exptype); is it a current experience? (=W_{current}); if not current experience, is it recent experience? (=W_{recent}); and, number of endorsements by other users (=W_{endorse}). With these factors, productivity can be calculated as follows,

Estimated Productivity=(W_{exptype}+W_{current}+W_{recent}+W_{endorse})×Periods of Experience

or weights may be multiplicated,

Estimated Productivity=(W_{exptype}×W_{current}×W_{recent}×W_{endorse})×Periods of Experience.

According to some embodiments, users may add more factors to be considered in the above equations.

Finally, a user may assign productivity curves to skills and/or skill clusters. Different types of productivity curves may be applied to different skills/skill clusters. For example, a productivity curve for a software engineer's skill may be steeper than one for a hardware engineer's skill. Graph 1010 of FIG. 10 is an example of the resulting productivity map. In this example, productivity is indicated by node's size. Different visual effects, such as color, thickness of lines, etc., may be used for visual representation of productivities.

According to some embodiments, the productivity map may be used to uncover the organization's actual capability on a specific skill set. Even if the skill map shows that the organization has 10 AI engineers, they may be all junior-level, and it may not be what the organization expects. Though it can be roughly detected by a filtering function that filters out skill data with greater than three years experience, for more thorough analysis, productivity curves such as illustrated in FIGS. 9 and 10 can be helpful. In other words, users would use a productivity map over a skill map especially when they consider that productivity is nonlinearly increased by skill level. This is also known as “The Mythical Man-Month” as discussed in Frederick Brooks, “The Mythical Man-Month: Essays on Software Engineering”, 1995, which is incorporated herein by reference.

On the other hand, existing solutions use skill data directly for analyses and assume that productivity linearly increases/decreases with respect to skill level.

Smart Filter. According to some embodiments, users can create a smart filter, which consists of multiple filters with a new label and apply it to a skill map.

One example of a smart filter is a filter named “single point of failure”, and it may consist of a set of filters, “skills a user is currently using”, “Skill used in industrial field”, “Experience periods is over 5 years in total”, and “The number of users with the skill is less than 3”. Another example is a filter named “General skill”, and it may 5 consist of a set of filters, “skills a user is currently using”, “Skill is used in industrial or academic fields”, “experience periods is over 3 years”, and “the number of users with the skill is more than 50% of all employees”. The configuration of each smart filter may be customized by users and default smart filters may be provided from the beginning.

Combinations of filters which are often used can be stored in the system with meaningful names to be used repeatedly, according to some embodiments. Smart filters can drastically reduce the number of user's input to configure filters over and over. This function also reduces the data size of requests sent to a server for filtering functions if the server stores all configurations of smart filters and the request only needs to specify filter's name or ID. Furthermore, the number of requests might be reduced because it reduces a chance of human error and no request with a wrong configuration of filtering won't be sent to the server anymore.

Conventional solutions may provide a simple filter such as “experience periods >N years”, but not provide an equivalent function described herein.

A concrete example of a software service which utilizes embodiments described in this document is illustrated in pages 44-51 of U.S. Prov. Ser. No. 63/111,547 filed Nov. 9, 2020, which is incorporated by reference herein in its entirety.

According to some embodiments, the following examples are described herein: (1) Extracting/Loading skills based on work experiences, which reduces a chance of registering skills subjectively and makes skill data as reliable as possible; (2) applying a graph to skill data management, removes subjective criteria of parent-child relationship of skill data and enables efficient skill data edit, merging multiple skill data; (3) suppression of duplicates of skill data by aliases and abbreviation DB, detect aliases and abbreviations and avoid users to register redundant skill data; (4) clustering skill data, clustering skill data represented in a graph with a proposed method, which takes into account users prior knowledge about skills and skill clusters; (5) productivity map, customizable baseline of productivity map and weights associated with skill data's attributes provides thorough analysis of skill data, especially productivity is considered nonlinear with respect to periods of experience; and (6) smart filter, store a set of filters with each label, such as “single point of failure”, to reduce chances of human error and for a better user experience.

These embodiments may be applied to skill data management and its applications. For example, see Appendix B U.S. Prov. Ser. No. 63/111,547 filed Nov. 9, 2020. Well-managed skill data may be used to find missing skills among employees and provide proper training and/or education to a subset of employees. Also, it may be used to find hidden experts of specific skills in an organization and optimize (re-)assignments of employees depending on the projects and requirements. Furthermore, it would be helpful when hiring new employees or outsourcing some tasks based on the missing skills in the organization.

Skill management is important in filling a digital skill gap, and these embodiments are configured to make it work practically and efficiently.

It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What it claimed is:

1. A method of exploiting skill data that speeds up an involved network system and reduces computer memory requirements, comprising:
computer-processing work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills;
computer-processing the extracted skill data into graphs each comprising a plurality of nodes interconnected by a plurality of edges as distinguished from a tree listing of skills, said nodes and edges each having one or more skill-related attributes associated therewith;
computer-processing said skill data and/or said graphs of nodes and edges, to suppress duplicates of skill data, including duplicates by alias and abbreviation, thereby reducing computer storage requirements of skill data in said graphs and in merged graphs compared with tree structures of skill data;
computer-processing said graphs of nodes and edges to selectively produce clustered skill data represented as graphs of nodes and edges;
computer-processing the skill data to produce productivity maps that non-linearly relate periods of experience in skills and productivity in skills;
storing smart filters that specify a search request for skill data by selected pluralities of attributes of skills, and searching the skill data by identities of said special filters rather than by listing the attributes included therein, thereby reducing errors in listing attributes of the special filters for searches and speeding up the involved networked system by reducing bandwidth of communicating search requests; and
utilizing said skill data and maps for computer-automated fitting of needs for skills to availability of skills.

2. The method of claim 1, in which said producing of productivity maps comprises applying to said graphs of skill data a combination of weights representing types of available experience in said skill, whether the experience is current, how recent is the experience, endorsement by others regarding said skill or experience, and periods of experience.

3. The method of claim 1, further including bottom-up dynamic editing of said nodes and/or edges in one or more of said graphs by user and/or expert input.

4. The method of claim 1, further including computer-processing a selected subset of said skill graphs to produce a team graph of nodes and edges representing combined skills of team members.

5. The method of claim 1, further including computer-processing a selected subset of said skill graphs to produce a team graph of nodes and edges representing combined skills of team members and further representing prioritized nodes and/or edges based on quality or extent of related skills.

6. The method of claim 1, in which said suppressing of duplicates of skill data comprises producing and storing aliases and abbreviations of skill names and using said stored aliases and abbreviations to suppress duplicates of nodes and/or edges.

7. The method of claim 1, further including producing graphs of non-linear relationships between periods of experience of individuals in respective skills and using said non-linear relationships in producing said productivity maps.

8. The method of claim 1, further including processing said graphs of nodes and edges to produce maps of geographical distributions of skills

9. The method of claim 1, in which said computer-processing of work experience date comprises presenting users with listings of skills over a network connection for selection of skills by users from said listings.

10. A method of exploiting skill data that speeds up an involved network system and reduces computer memory requirements, comprising:
computer-processing work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills;
computer-processing the extracted skill data into graphs each comprising a plurality of nodes interconnected by a plurality of edges as distinguished from a tree listing of skills, said nodes and edges each having one or more skill-related attributes associated therewith;
computer-processing said skill data and/or said graphs of nodes and edges to suppress duplicates of skill data, including duplicates by alias and abbreviation, thereby reducing computer storage requirements of skill data in said graphs and in merged graphs compared with tree structures of skill data;
computer-processing said graphs of nodes and edges to selectively produce clustered skill data represented as graphs of nodes and edges;
computer-processing the skill data to produce productivity maps that non-linearly relate periods of experience in skills and productivity in skills;
storing smart filters that specify a search request for skill data by selected pluralities of attributes of skills, and searching the skill data by identities of said special filters rather than by listing the attributes included therein, thereby reducing errors in listing attributes of the special filters for searches and speeding up the involved networked system by reducing bandwidth of communicating search requests; and
utilizing said skill data and maps for computer-automated fitting of needs for skills to availability of skills.

11. The method of claim 10, in which said producing of productivity maps comprises applying to said graphs of skill data a combination of weights representing types of available experience in said skill, whether the experience is current, how recent is the experience, endorsement by others regarding said skill or experience, and periods of experience.

12. The method of claim 10, further including bottom-up dynamic editing of said nodes and/or edges in one or more of said graphs by user and/or expert input.

13. The method of claim 10, further including computer-processing a selected subset of said skill graphs to produce a team graph of nodes and edges representing combined skills of team members.

14. The method of claim 10, further including computer-processing a selected subset of said skill graphs to produce a team graph of nodes and edges representing combined skills of team members and further representing prioritized nodes and/or edges based on quality or extent of related skills.

15. The method of claim 10, in which said suppressing of duplicates of skill data comprises producing and storing aliases and abbreviations of skill names and using said stored aliases and abbreviations to suppress duplicates of nodes and/or edges in said graphs and/or in said clustered skill data.

16. The method of claim 10, further including producing graphs of non-linear relationships between periods of experience of individuals in respective skills and using said non-linear relationships in producing said productivity maps.

17. The method of claim 10, further including processing said graphs of nodes and edges to produce maps of geographical distributions of skills.

18. The method of claim 10, in which said computer-processing of work experience date comprises presenting users with listings of skills over a network connection for selection of skills by users from said listings.

19. A system exploiting skill data, comprising:
a computer-implemented facility configured to process work experience data of individuals to extract skill data objectively, including skill data that is implicit though not explicitly specified in said experience data, thereby reducing subjectivity in associating skills with individuals, making the extracted skill data more reliable, and speeding an involved network systems by reducing need for active two-way questioning of individuals regarding their skills;
a computer-implemented facility configured to convert the extracted skill data into graphs each comprising a plurality of nodes interconnected by a plurality of edges as distinguished from a tree listing of skills, said nodes and edges each having one or more skill-related attributes associated therewith;
a computer-implemented facility configured to suppress duplicates of skill data in said graphs, including duplicates by alias and abbreviation, thereby reducing computer storage requirements of said graphs and merged versions thereof compared with tree structures of skill data;
a computer-implemented facility configured to combine selected graphs of nodes and edges to selectively produce clustered skill data represented as graphs of nodes and edges;
a computer-implemented facility configured to produce productivity maps that non-linearly relate periods of experience in skills and productivity in skills;
a computer-implemented facility configured to store smart filters that specify a search request for skill data by selected pluralities of attributes of skills, and to search the skill data by identities of said special filters rather than by listing the attributes included therein, thereby reducing errors in listing attributes of the special filters for searches and speeding up an involved network system by reducing transmission of search requests that include a listing of attributes; and
a computer-implemented facility configured to utilize said skill data and maps for computer-automated fitting of needs for skills to availability of skills.

20. The system of claim 19, further including a computer facility configured for bottom-up dynamic editing of said nodes and/or edges in one or more of said graphs by user and/or expert input.
